(19) United States
(12) Patent Application Publication
(10) Pub. No.: US 2025/0021788 A1
(43) Pub. Date: Jan. 16, 2025

(54) IMPROVING COLLECTIVE PERFORMANCE OF MULTI-AGENTS

(71) Applicant: Telefonaktiebolaget LM Ericsson (publ), Stockholm (SE)

(72) Inventors: Perepu SATHEESH KUMAR, Chennai (IN); Kaushik DEY, Kolkata (IN)

(73) Assignee: Telefonaktiebolaget LM Ericsson (publ), Stockholm (SE)

(21) Appl. No.: 18/713,366

(22) PCT Filed: Nov. 26, 2021
(86) PCT No.: PCT/IN2021/051103

§ 371 Date: May 24, 2024

(51) Int. Cl. G06N 3/004

(52) U.S. Cl. CPC G06N 3/004

(57) ABSTRACT

A method is provided. The method comprises obtaining local observation data of a group of one or more agents. The local observation data indicates performance of each agent included in the group. The method further comprises obtaining global state data indicating collective performance of the group and based on the obtained local observation data and the obtained global state data, determining a discount factor for each agent included in the group. The discount factor is a weight value of a future expected reward for each agent included in the group.

### TECHNICAL FIELD

Disclosed are embodiments related to methods and systems for improving collective performance of multi-agents.

### BACKGROUND

Reinforcement learning (RL) is one of techniques which can be used in different applications. RL involves an agent to find an optimal policy to take action(s) and obtain high reward from the environment the agent is interacting with. The policy is optimized as the reward from the environment increases.

RL assumes that the underlying process is stochastic and follows a Markov Decision Process (“MDP”). In the MDP, it is assumed that the current state (tₛ) of a system depends only on the one previous state (tₛ₋₁) not on the entire previous states (tₛ₋₁, tₛ₋₂, tₛ₋₃, . . . ). The underlying process is called a model in the RL context. Quite often, the underlying model of the system is unknown. In such case, model-less RL methods (e.g., Q-learning, SARSA, etc.) may be used.

There are two functions in RL—a policy function and a value function. In many cases, the user needs to specify the value function but computing the value function is not easy for the system with many actions and states. In such case, a neural network (e.g., a deep neural model) may be used to approximate the value function. This is known as deep RL.

The RL neural network takes the states of the environment as the input and outputs a Q value. Based on the output Q value for each action, the agent selects an action which generates high reward. Here the RL neural network is updated based on the actual reward obtained and expected reward. The network is trained until the agent reaches the terminal state or a particular number of episodes is completed.

In a multi-agent scenario, different agents participate together and work towards either collaboratively or competitively. For example, in the collaborative environment, multiple agents may work towards a common goal.

Generally, in the RL, agents are trained in simulation (i.e., by collecting the data and using the trained agents in real-time). However, the performance of these agents will not be good in real-time since the real-time environment will have inherent stochasticity. Thus there is a need for a method to train agents with inherent stochasticity so that the performance of agents is good even in real-time.

In Sunehag, Peter, Guy Lever, Audrunas Gruslys, Wojciech Marian Czarnecki, Vinicius Zambaldi, Max Jaderberg, Marc Lanctot et al. “Value-decomposition networks for cooperative multi-agent learning.” arXiv preprint arXiv:1706.05296 (2017), a value decomposition method (VDN) is proposed. The VDN updates the Q-networks of individual agents based on a sum of all of the agent value functions using centralized training and decentralized execution. However, the same may not consider the extra state information of the environment and also it cannot be applied to all the general multi-agent reinforcement learning (MARL) problems and particularly where joint Q function is not a linear function of individual Q functions.

To address this problem, in Rashid, Tabish, Mikayel Samvelyan, Christian Schroeder, Gregory Farquhar, Jakob Foerster, and Shimon Whiteson. “Qmix: Monotonic value function factorisation for deep multi-agent reinforcement learning.” In International Conference on Machine Learning, pp. 4295-4304. PMLR, 2018, a QMIX method is proposed. The QMIX method lies between extremes of VDN and counterfactual multi-agent (COMA).

The proposed approach uses a mixing network which mixes the individual agents' value functions through a mixing network which is then used to obtain a global Q value. Further the agents' value functions are trained based on the global Q value and the mixing network is trained by conditioning the same on the state of the environment. In this way the state of the environment may be added while training the individual agents. Also the agents are trained based on other agents' performance. However, the issue with this approach is that the value functions of individual agents should monotonically increase with respect to the global Q value.

To handle the stricter non-monotonic assumption, in Mahajan, Anuj, Tabish Rashid, Mikayel Samvelyan, and Shimon Whiteson. “Maven: Multi-agent variational exploration.” arXiv preprint arXiv:1910.07483 (2019), a method known as Multi-Agent Variational Exploration (MAVEN) is proposed. The MAVEN may be used to train decentralized policies for agents conditioning their behaviors on the shared latent variables controlled by a hierarchical policy.

### SUMMARY

Certain challenges exist. All of the above methods generally assume that all agents behave exactly in the way as their policies instructed them. However, in many cases, at least some agents can behave in entirely stochastic way. In other words, there may be some agents that execute actions that are different from the actions instructed by the policies. This behavior is due to either the stochasticity in the environment or stochasticity in the agents itself. The degree of stochasticity can be different among different agents. This is a common phenomenon in industries where policies are learned using agents which may become stochastic i.e., as they get old and undergo wear and tear, the agents may not always be able to follow the strict demands of the policy.

Accordingly, in one aspect, there is provided a method. The method comprises obtaining local observation data of a group of one or more agents, wherein the local observation data indicates performance of each agent included in the group. The method further comprises obtaining global state data indicating collective performance of the group. The method further comprises based on the obtained local observation data and the obtained global state data, determining a discount factor for each agent included in the group. The discount factor is a weight value of a future expected reward for each agent included in the group.

In another aspect, there is provided a computer program comprising instructions (744) which when executed by processing circuitry cause the processing circuitry to perform the method described above.

In another aspect, there is provided an apparatus. The apparatus is configured to obtain local observation data of a group of one or more agents, wherein the local observation data indicates performance of each agent included in the group. The apparatus is further configured to obtain global state data indicating collective performance of the group. The apparatus is further configured to, based on the obtained local observation data and the obtained global state data, determine a discount factor for each agent included in the group. The discount factor is a weight value of a future expected reward for each agent included in the group.

In another aspect, there is provided an apparatus. The apparatus comprises a memory; and processing circuitry coupled to the memory, wherein the apparatus is configured to perform the method described above.

The embodiments of this disclosure allow (i) achieving good collaboration between agents with varying degrees of stochasticity and (ii) enabling agents to learn with a smaller number of samples. Also the computational time of the method according to the embodiments is not higher than the computational time of the existing methods.

### BRIEF DESCRIPTION OF THE DRAWINGS

The accompanying drawings, which are incorporated herein and form part of the specification, illustrate various embodiments.

FIG. 1 shows an exemplary environment.

FIG. 2 shows the concept of reinforcement learning.

FIG. 3 shows a module according to some embodiments.

FIG. 4 shows a system according to some embodiments.

FIG. 5 shows a process according to some embodiments.

FIG. 6 shows an apparatus according to some embodiments.

### DETAILED DESCRIPTION

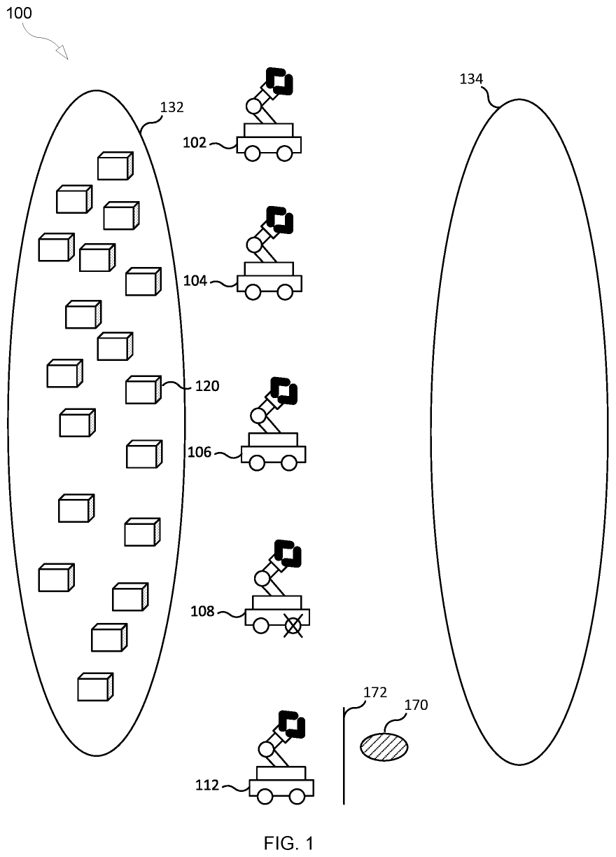

Embodiments of this disclosure are explained using an exemplary environment 100 shown in FIG. 1 for simple explanation. However, the embodiments are not limited to the environment 100 and can be applied in various environments.

FIG. 1 shows the exemplary environment 100 according to some embodiments. The environment 100 may include a first robot 102, a second robot 104, a third robot 106, a fourth robot 108, and a fifth robot 112. The number of the robots shown in FIG. 1 is provided for illustration purpose only and do not limit the embodiments of this disclosure in any way.

In the exemplary environment 100 shown in FIG. 1, the robots 102-112 are configured to move various objects 120 from a first area 132 to a second area 134. For example, the robots 102-112 may be used in a warehouse for moving various commercial goods from a storage area 132 to a packaging area 134 such that the goods can be packed and shipped to consumers.

In the environment 100, each of the robots 102-112 is an agent. In this disclosure, an agent is an entity that is configured to interact and/or act within the environment 100. It may be a software entity or a physical entity including software.

The robots 102-112 are configured to operate in particular ways according to one or more policies provided by a control entity. The control entity may be a processor included in each of the robots or may be a computer or a server that is remote from the robots. The policy is a mapping between different states of the environment 100 and the agent's different actions. The policy is for providing the appropriate action for one or more agents in a given state of the environment. The policy may be same for all agents or may be different for each agent.

Table 1 below shows an example of a simplified policy for the robot 102.

| State | Action |
|---|---|
| The remaining amount of goods to be packed = low | Operate at speed V1 |
| The remaining amount of goods to be packed = high | Operate at speed V2 |

As shown in Table 1 above, in case the state of the environment 100 indicates that the amount of goods in the packing area 134 that are waiting to be packed is lower than a threshold, the policy may instruct the robot 102 to operate at a higher speed such that more goods are delivered to the packing area 134 from the storage area 132. On the other hand, if the state of the environment 100 indicates that the amount of goods in the packing 134 that are waiting to be packed is higher than a threshold, the policy may instruct the robot 102 to operate at a lower speed such that less goods are delivered to the packing area 134 from the storage area 132.

Each agent may be configured to use the policy or policies to maximize the overall reward of the environment 100 gained from transitioning between different states of the environment 100. In one example, the overall reward of the environment 100 is that the time interval between receiving an online order for a goods from a customer and shipping the goods to the consumer is less than a predetermined amount of time.

By default, each of the robots 102-112 may be configured to operate exactly according to given policies. However, there may be a scenario where one or more of the robots 102-112 behaves in a stochastic way partially or entirely. This stochasticity of the behaviors of the robots 102-112 may be due to an robot's condition. For example, a robot may behave in a stochastic way due to wear and tear of the robot which may be caused by a continuous usage of the robot. In the environment 100 shown in FIG. 1, the robot 108's one of wheels is broken and thus the robot 108 may not move in a way instructed by the policy.

The stochasticity of the behaviors of the robots may also be caused by the factors affecting part(s) of the environment. For example, in the environment 100 (e.g., a warehouse) shown in FIG. 1, the robot 112 may not move in a way instructed by the policy because of an oil 170 or an obstacle 172 existed on its path. The oil 170 may exist in the environment 100 only occasionally and may not exist at all times. In such scenario, the robots may have to retune their policies such that they can perform effectively.

In the examples provided above, since the robots 102-106 behave accurately according to the given policies, the robots 102-106 are “deterministic” agents. On the other hand, since the robots 108 and 112 do not behave accurately according to the given policies 158 and 162, the robots 108 and 112 are “stochastic” agents.

In order to maximize the reward (e.g., minimizing the time interval between the timing of receiving an online order of a goods from a customer and the timing of shipping the goods) of an overall joint policy (that comprises the plurality of policies for each robot), the robots 102-112 must be coordinated successfully. Such successful coordination of the robots 102-112 may depend on (i) the deterministic robots 102-106's understanding of the limitations and/or the behaviors of the stochastic robots 108 and 112 and (ii) appropriate tuning of the respective policies for maximizing the reward of the overall joint policy.

In some embodiments of this disclosure, a reinforcement learning (RL) may be used to determine actions that the robots 102-112 may take in order to maximize the collective reward.

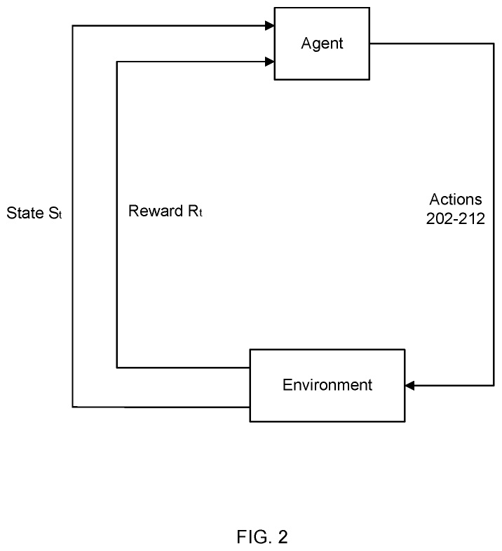

FIG. 2 shows the concept of single agent RL. As shown in FIG. 2, each of the robots (a.k.a., agents) 102-112 takes an individual action 202, 204, 206, 208, or 212. The collection of the individual actions 202-212 causes the state of the environment 100 to change from a current state Sₜ to a next state Sₜ₊₁ and result in reward rₜ. Based on the reward n and the next state Sₜ₊₁, the next actions of the robots 102-112 are determined. The collection of these next actions of the robots 102-112 causes the state of the environment 100 to change from the state Sₜ₊₁ to a next state Sₜ₊₂ and result in reward rₜ₊₁.

To mathematically formulate the above described RL problem, a Markov Decision Process (MDP) may be used. The MDP satisfies the Markov property which is that the current state of the environment completely characterizes the state of the environment.

An MDP is defined by tuple of objects comprising S, A, R, γ, where S is a set possible states, A is a set of possible actions, R is a distribution of reward given a state-action pair, and γ is a discount factor (DF). The MDP may begin at the time instance t=0. At the time instance t=0, for the current state sₜ, an agent selects an action at. Based on the action at, the environment samples a reward n and a next state sₜ₊₁. The agent receives the reward n and the next state Sₜ₊₁.

A policy π is a function of mapping the agent's action to a state. The policy specifies what action an agent can take in each state of the environment. The MDP may be used to find the best policy π* that maximizes a cumulative discounted reward over a time interval. In other words, the optimal policy π* is the one that maximize the sum of rewards.

The optimal Q-value function Q* is the maximum expected cumulative reward achievable from a given state-action pair. For example, Q*(s,a) may be expressed as follows:

$$\\ {Q}^{{}_{} *} ( s , a ) = max [ {\sum }_{t \geq 0} {γ}^{{}_{} t} {r}_{t} \vert {s}_{0} = s , {a}_{0} = a , π ]$$

Q* satisfies the following Bellman equation:

$$\\ {Q}^{{}_{} *} ( s , a ) = [ r + γ max Q * ( {s}^{{}_{} ′} , {a}^{{}_{} ′} ) \vert s , a ]$$

Here, if the optimal state-action values for the next time step Q*(s′,a′) are known, then the optimal strategy is to take the action that maximizes the expected value of r+γQ(s′, a′)*(s′, a′)|

The optima π* corresponds to taking the best action in any state specified by Q*.

Referring back to FIG. 1, in the system 100, the robots 102-106 are deterministic agents while the robots 108 and 112 are stochastic agents. Since the behaviors of the stochastic agents are unpredictable, in calculating the Q value for each agent, less weight (Y) should be given to the future Q values of the stochastic agents as compared to the future Q values of the deterministic agents. The rationale is that since the future Q values of an agent are determined based on how well the agent will perform in the future but how well a stochastic agent will perform in the future is unpredictable, less weight should be given to the future Q values of the stochastic agent.

Accordingly, in some embodiments, a lower DF is used for highly stochastic agents (e.g., the robots 108 and 112) such that the Q values of the stochastic agents depend on short-term actions and not so much on the long-term actions. On the contrary, a higher DF may be used for the deterministic agents such that the Q values of the deterministic agents depend more on future values (as compared to the deterministic agents).

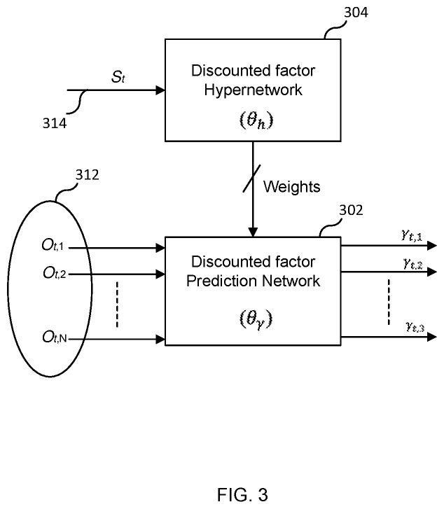

FIG. 3 shows a DF calculating module 300 according to some embodiments. The module 300 may be configured to calculate a DF for each agent (e.g., the robots 102-112). The module 300 may be a hardware entity or a software entity (e.g., one or more neural networks).

As shown in FIG. 3, the module 300 may comprise a DF prediction network (θₕ) 302 and a DF hypernetwork (θ_{γ}) 304. Each of the networks 302 and 304 may be a neural network.

The DF prediction network 302 may be configured to receive local observation data 312 of the agents and a plurality of weight values 314, and to calculate a DF for each of the agents based on the received local observation data and the received plurality of weight values.

The local observation data 312 may include a first set (e.g., a vector) of local observation parameter values O_{t,1} obtained at time instant t for a first agent, a second set of local observation parameter values O_{t,2} obtained at the time instant t for a second agent, . . . , and a N^{th} set of local observation parameter values O^{t,N} obtained at the time instant t for the N^{th} agent in the environment.

One of the reasons why the local observation data of the agents is used for calculating the DFs for the agents is because the local observation data of each agent may indicate the degree of stochasticity of each agent. For example, in the system 100 shown in FIG. 1, the local observation data of the robot 108 may include a first parameter indicating the speed of the robot 108 when it moved from the storage area 132 to the packing area 134 and a second parameter indicating how straight the robot 108 moved when it moved from the storage area 132 to the packing area 134. The combination of the indicated speed and the straightness of the movement of the robot 108 may indicate the degree of the stochasticity of the robot 108. For example, if the indicated speed is substantially lower than the speed of other robots 102-106 and/or the indicated straightness of the movement is substantially worse than the straightness of the movements of other robots 102-106, it may be determined that the robot 108 behaves in a stochastic manner, and thus is a stochastic agent. Because the local observation data of each agent may relate to the degree of the stochasticity of each agent, in some embodiments, the DF of an agent is determined at least based on the local observation data of the agent.

Referring back to FIG. 3, the weight values 314 may include a first set (e.g., a vector) of weight values θ_{γ,1} for the first agent, a second set of weight values θ_{γ,2} for the second agent, . . . , and a N^{th} set of weight values θ_{γN}. for the N^{th} agent.

As discussed above, the DF for each agent may be calculated not only based on the local observation data of each agent but also based on the global state of the environment. The global state of the environment indicates the collective performance of all the agents. By calculating the DF for each agent based not only on the local observation data but also on the global state, each agent's performance with respect to the collective performance of all agents can be considered in calculating the DF. However, because the local observation data and the global state data are in different scales and because the DFs of the agents need to be between 0 and 1, the global state of the environment cannot be used as a direct input to the DF prediction network 302.

Accordingly, in some embodiments, the DF hypernetwork 304 is configured to receive the global state data S, at time instant t as an input and generate the weight values 314 based on the received global state data Sₜ.

There are different ways for the DF prediction network 302 to calculate the DFs for the agent. In one embodiment, the DF prediction network 302 is a neural network having a function ƒₐ(W, Oₜ) where ƒₐ can be either a linear function or a non-linear function, W is a vector or a matrix of the weight values 314 for all agents, and Oₜ is a vector or a matrix of local observation parameter values for all agents. The DF prediction network 302 may be configured to generate a set (e.g., a vector) of DF values for all agents.

For example, a DF value for the robot 102 (γ₁) may be calculated as follows: γ₁=ƒₐ (wᵢ,o_{t,1})+ƒₐ(wᵢ,o_{t,2})+ . . . +ƒₐ(wᵢ,o_{r,N}), where wᵢ is a weight value associated with the robot 102, of o_{t,1} is a value of the local observation parameter of the robot 102, of o_{t,2} is a value of the local observation parameter of the robot 104, . . . , and o_{t,N} is a value of the local observation parameter of the robot 112 (in the environment 100, N=5). Note that for simple explanation, it is assumed here that the set of local observation parameters of the robot 102 consists of a single parameter and the weight value associated with the robot 102 includes a single weight value.

Referring back to FIG. 3, as discussed above, the weight values 314 may be calculated using the DF hypernetwork 304 based on the global state value Sr. For example, the weight values 314 (W) may be equal to Wₕ*Sₜ where the Wₕ is a set of weight values for the DF hypernetwork 304 and S, is the global state value.

The DF values calculated from the module 300 may be used to improve the collective performance of the agents (e.g., the robots 102-112).

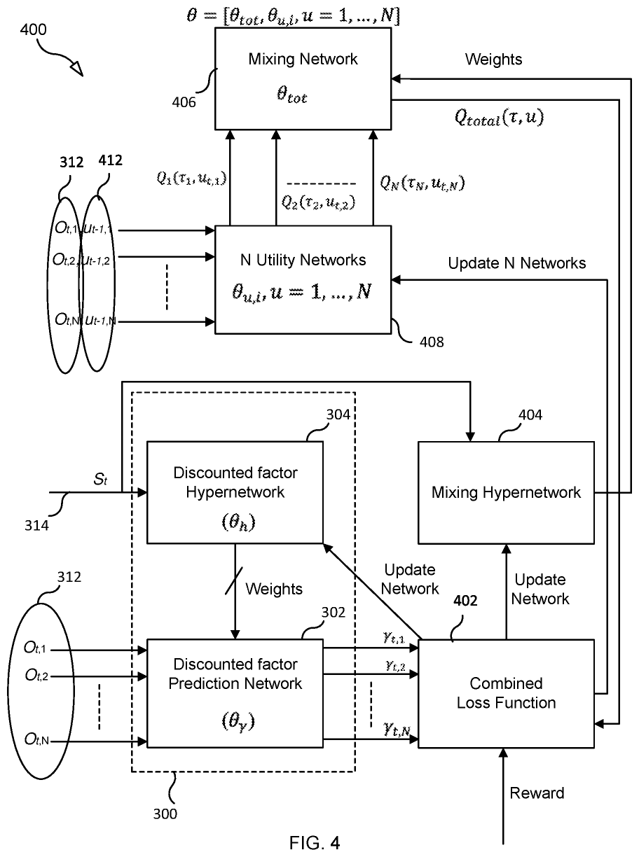

FIG. 4 shows a system 400 for improving the collective performance of multi-agents (e.g., the robots 102-112) in an environment (e.g., the environment 100) according to some embodiments. The system 400 may comprise the DF calculating module 300 shown in FIG. 3, a loss function-based updater 402, a mixing hypernetwork module 404, a mixing network module 406, and a utility network module 408. Each of the modules included in the system 400 may be a hardware entity or a software entity (e.g., a neural network).

The utility network module 408 may be configured to receive the local observation data 312 and action data 412 for all agents in the environment. The local observation data may include a set of one or more local observation parameters O_{t,1} for a first agent at time instance t, a set of one or more local observation parameters O_{t,2} for a second agent at the time instance t, . . . , and a set of one or more local observation parameters O_{t,N} for a N^{th} agent at the time instance t.

The action data 412 may include a set of one or more action parameters u_{t-1,1} for the first agent at time instance t−1, a set of one or more action parameters u_{t-1,2} for the second agent at the time instance t−1, . . . , and a set of one or more action parameters u_{t-1,N} for the N^{th} agent at the time instance t−1. Taking the environment 100 shown in FIG. 1, as an example, the set of one or more action parameters u_{t-1,1} for the first robot 102 may include the direction of the robot 102's previous movement at the time instance t−1 and/or the speed of the robot 102's movement at the time instance t−1.

The utility network module 412 may be configured to generate a reward Q₁, Q₂, . . . . Q_{N} for each of the agents.

The mixing network module 406 may be configured to receive the rewards Q₁-Q_{N} and determine a collective reward value Qₜₒₜₐₗ for all agents. The weights used in calculating the collective reward value Qₜₒₜₐₗ may be calculated using the weights obtained from the mixing hypernetwork module 404. In some embodiments, the mixing hypernetwork module 404 may be configured to output the weights based on the global state data Sr.

Based on the received collective reward value Qₜₒₜₐₗ and the received discount factor values (γ₁, γ₂, . . . , γ_{N}), using a loss function, the updater 402 may optimize the weights used in the DF hyper network module 304 and the mixing network module 406. By optimizing such weights, the optimal DF values for the agents may be calculated.

In one embodiment, the loss function may be expressed as follows:

$$\\ L ( θ , {θ}_{h} ) = {\sum }_{t = 1}^{B} ( {r}^{{}_{} t} + max g ( {u}^{{}_{} ′} , {s}^{{}_{} ′} , {f}_{γ} ( {O}_{1}^{{}_{} t} , … , {O}_{N}^{{}_{} t} , {f}_{h} ( {θ}_{h} , {s}^{{}_{} ′} ) ) ) {Q}_{u , i} , θ ) - {Q}_{tot} ( τ , u , s )$$

ƒₕ(θₕ, s′) is a function of the DF hyper network module 304 and ƒ_{γ}(O₁^{t}, . . . , O_{N}^{t}, ƒₕ(θₕ, s′)) is a function of the DF prediction network 302. g is a function of calculating the Q value, and r^{t} is a reward for a particular value of t.

In the system 400, for every B samples, the hyper network θₕ is updated for a fixed θ and then θ is updated for the updated θₕ. Thus, at each step θ and θₕ are updated iteratively.

### Exemplary Use Case #1

The above method and/or systems for improving the collective performance of multi-agents can be used in the field of 5G network. More specifically, the above methods and/or systems can be used to distribute network resources to different network functions for providing different network services such that the collective performance of the network functions can be optimized.

The resources required for each network function to provide the service may depend on many factors. One example of such factors is the number of user equipments (UEs) using the service. However, there may be a scenario where the number of UEs using a particular service may change significantly with time. In such scenario, the network function responsible for providing the particular service can be considered to be a stochastic agent.

Thus, in some embodiments, different discount factors may be applied to different network functions depending on the degree of the stochasticity of each network function. For example, in case there is a frequent change in the number of UEs using a first service associated with a first network function and there is less frequent change in the number of UEs using a second service associated with a second network function, because the service provided by the first network function is more unpredictable, a higher discount factor may be applied to the first network function as compared to the second NF.

Generally, to train an RL agent, simulated data and the trained agent are used in real time. However, to match the performance, it is needed to train the agents under different factors which is often difficult to collect. Using the embodiments of this disclosure, the agents can be trained quickly as unobserved factors can be attributed to stochasticity.

Here, only a small number of samples are required for the training, which will reduce the human effort and lower cost. In this way a good efficient model can be obtained within a shorter time period. If the number of UEs changes frequently for a particular service, then the agent responsible for the service should take actions by looking at smaller time horizon since the decisions taken now may not be valid when number of UE's change frequently.

### Exemplary Use Case #2

The use case #2 deals with private networks in industry 4.0 setting. In an exemplary industry 4.0 setting, there may be a plurality of machines that are connected via a network and are configured to operate in a factory. Each of the machines may be configured to perform a particular job upon receiving command(s) via the network and, to deliver the command(s) to each of the machines, a particular size of network resources may be allocated to each of the machines.

For example, network resources having a first bandwidth may be allocated to a first machine for performing less complex job and network sources having a second bandwidth that is greater than the first bandwidth may be allocated to a second machine for performing more complex job.

In such setting, there may be a scenario where some of the machines get degraded and/or become broken, and thus the machines behave in a stochastic manner. In such scenario, using the method and/or the system described above, the jobs of the machines and the amount of network resources allocated to the machines to perform the jobs can be redistributed such that complex and/or time-consuming tasks are handled by good machines (i.e., deterministic agents), and less complex and less time-consuming tasks are handled by degraded or broken machines (i.e., stochastic agents). More specifically, the optimal discount factor values for the good machines and the bad machines can be determined such that the jobs and the network resources are allocated to the machines optimally. By properly allocating the jobs to the machines, the overall efficiency and the collective performance of the machines can be improved. Also, by properly allocating the network resources to the machines, the usage of the network can be optimized.

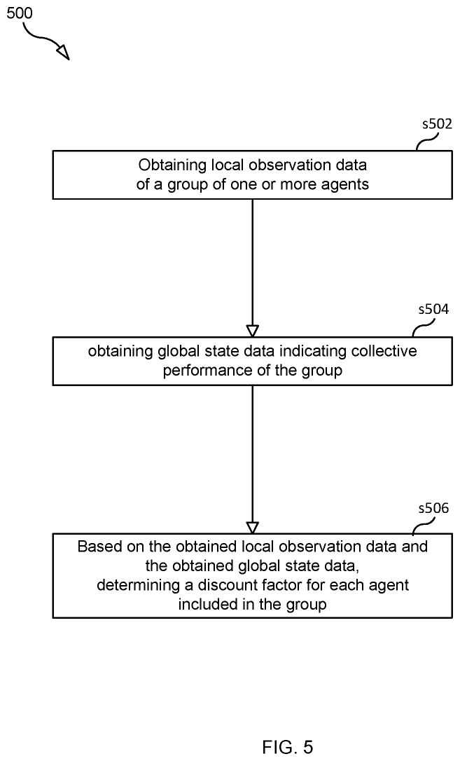

FIG. 5 shows a process 500 according to some embodiments. The process 500 may begin with step s502. Step s502 comprises obtaining local observation data of a group of one or more agents, wherein the local observation data indicates performance of each agent included in the group. Step s504 comprises obtaining global state data indicating collective performance of the group. Step s506 comprises based on the obtained local observation data and the obtained global state data, determining a discount factor for each agent included in the group. The discount factor is a weight value of a future expected reward for each agent included in the group.

In some embodiments, the local observation data indicates the performance of each agent in a current state of an environment, the global state data indicates the collective performance of the group in the current state of the environment, and the discount factor is for a next sequential state of the environment that is after the current state of the environment.

In some embodiments, the group of one or more agents includes a first agent and a second agent, the local observation data indicates that performance of the first agent deviates from performance of the agents included in the group by a first degree, the local observation data indicates that performance of the second agent deviates from performance of the agents included in the group by a second degree, the first degree is greater than the second degree, and the discount factor of the first agent is less than the discount factor of the second agent.

In some embodiments, determining the discount factor for each agent comprises: obtaining a plurality of weights of a prediction neural network; and applying the obtained plurality of weights to the local observation data via the prediction neural network, thereby determining the discount factors for the agents included in the group.

In some embodiments γᵢ=f((w₁, . . . w_{N}) (O_{t,1}, . . . , O_{t,N})), where γᵢ is a discount value for ith agent included in the group, w₁ is a weight for a first agent included in the group, w_{N} is a weight for a Nth agent included in the group, O_{t,1} is local observation data for the first agent, O_{t,N} is local observation data for the Nth agent, and f is a non-linear function.

In some embodiments, γᵢ=fₐ(w₁*O_{t,1})+ . . . +fₐ(w_{N}*O_{t,N}).

In some embodiments, γᵢ=(w₁+O_{t,1})+ . . . +(w_{N}*O_{t,N}).

In some embodiments, obtaining the plurality of weights of the prediction neural network comprises determining the plurality of weights using a hypernetwork and the global state data.

In some embodiments, the method further comprises determining a prediction cumulative reward function for each agent included in the group using a current reward value of each agent, future reward values of each agent, and the discount value associated with each agent.

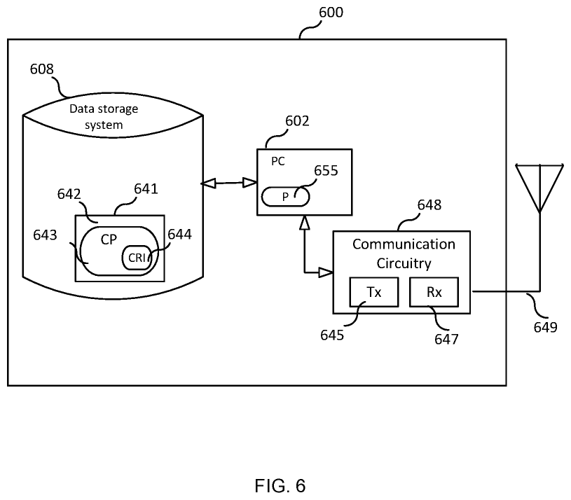

FIG. 6 is a block diagram of a system 600, according to some embodiments. The system 600 may be configured to perform the method 500 shown in FIG. 5. As shown in FIG. 6, the system 600 may comprise: processing circuitry (PC) 602, which may include one or more processors (P) 655 (e.g., one or more general purpose microprocessors and/or one or more other processors, such as an application specific integrated circuit (ASIC), field-programmable gate arrays (FPGAs), and the like); communication circuitry 648, which is coupled to an optional antenna arrangement 649 comprising one or more antennas and which comprises a transmitter (Tx) 645 and a receiver (Rx) 647 for enabling the system 600 to transmit data and receive data (e.g., wirelessly transmit/receive data); and a local storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes the system 600 to perform steps described herein (e.g., steps described herein with reference to the flow charts). In other embodiments, the system 600 may be configured to perform steps described herein without the need for code. That is, for example, PC 602 may consist merely of one or more ASICs. Hence, the features of the embodiments described herein may be implemented in hardware and/or software.

1. A method comprising:
obtaining local observation data of a group of one or more agents, wherein the local observation data indicates performance of each agent included in the group;
obtaining global state data indicating collective performance of the group; and
based on the obtained local observation data and the obtained global state data, determining a discount factor for each agent included in the group, wherein
the discount factor is a weight value of a future expected reward for each agent included in the group.

2. The method of claim 1, wherein
the local observation data indicates the performance of each agent in a current state of an environment,
the global state data indicates the collective performance of the group in the current state of the environment, and
the discount factor is for a next sequential state of the environment that is after the current state of the environment.

3. The method of claim 1, wherein
the group of one or more agents includes a first agent and a second agent,
the local observation data indicates that performance of the first agent deviates from performance of the agents included in the group by a first degree,
the local observation data indicates that performance of the second agent deviates from performance of the agents included in the group by a second degree,
the first degree is greater than the second degree, and
the discount factor of the first agent is less than the discount factor of the second agent.

4. The method of claim 1, wherein determining the discount factor for each agent comprises:
obtaining a plurality of weights of a prediction neural network; and
applying the obtained plurality of weights to the local observation data via the prediction neural network, thereby determining the discount factors for the agents included in the group.

5. The method of claim 4, wherein γᵢ=f((w₁, . . . w_{N})(O_{t,1}, . . . , O_{t,N})), where γᵢ is a discount value for ith agent included in the group, wᵢ is a weight for a first agent included in the group, w_{N} is a weight for a Nth agent included in the group, O_{t,1} is local observation data for the first agent, O_{t,N} is local observation data for the Nth agent, and f is a non-linear function.

6. The method of claim 5, wherein γᵢ=ƒₐ(w₁+O_{t,1})+ . . . +ƒₐ(w_{N}+O_{t,N}).

7. The method of claim 6, wherein γᵢ=(w₁+O_{t,1})+ . . . +(w_{N}*O_{t,N}).

8. The method of claim 4, wherein obtaining the plurality of weights of the prediction neural network comprises determining the plurality of weights using a hypernetwork and the global state data.

9. The method of claim 1, further comprising:
determining a prediction cumulative reward function for each agent included in the group using a current reward value of each agent, future reward values of each agent, and the discount value associated with each agent.

10-11. (canceled)

12. An apparatus comprising:
a memory; and
processing circuitry coupled to the memory, wherein the apparatus is configured to:
obtain local observation data of a group of one or more agents, wherein the local observation data indicates performance of each agent included in the group;
obtain global state data indicating collective performance of the group; and
based on the obtained local observation data and the obtained global state data, determine a discount factor for each agent included in the group, wherein
the discount factor is a weight value of a future expected reward for each agent included in the group.

13-14. (canceled)

15. The apparatus of claim 12, wherein
the local observation data indicates the performance of each agent in a current state of an environment,
the global state data indicates the collective performance of the group in the current state of the environment, and
the discount factor is for a next sequential state of the environment that is after the current state of the environment.

16. The apparatus of claim 12, wherein
the group of one or more agents includes a first agent and a second agent,
the local observation data indicates that performance of the first agent deviates from performance of the agents included in the group by a first degree,
the local observation data indicates that performance of the second agent deviates from performance of the agents included in the group by a second degree,
the first degree is greater than the second degree, and
the discount factor of the first agent is less than the discount factor of the second agent.

17. The apparatus of claim 12, wherein determining the discount factor for each agent comprises:
obtaining a plurality of weights of a prediction neural network; and
applying the obtained plurality of weights to the local observation data via the prediction neural network, thereby determining the discount factors for the agents included in the group.

18. The apparatus of claim 17, wherein γᵢ=f((w₁, . . . w_{N})(O_{t,1}, . . . , O_{t,N})), where γᵢ is a discount value for ith agent included in the group, w₁ is a weight for a first agent included in the group, w_{N} is a weight for a Nth agent included in the group, O_{t,1} is local observation data for the first agent, O_{t,N} is local observation data for the Nth agent, and f is a non-linear function.

19. The apparatus of claim 18, wherein γᵢ=ƒₐ(w₁+O_{t,1})+ . . . +ƒₐ(w_{N}+O_{t,N}).

20. The apparatus of claim 19, wherein γᵢ=(w₁+O_{t,1})+ . . . +(w_{N}+O_{t,N}).

21. The apparatus of claim 17, wherein obtaining the plurality of weights of the prediction neural network comprises determining the plurality of weights using a hypernetwork and the global state data.

22. The apparatus of claim 12, wherein the apparatus is further configured to:
determine a prediction cumulative reward function for each agent included in the group using a current reward value of each agent, future reward values of each agent, and the discount value associated with each agent.

23. A computer program product comprising a non-transitory computer readable medium storing instructions which when executed by processing circuitry of a system causes the system to perform a process that comprises:
obtaining local observation data of a group of one or more agents, wherein the local observation data indicates performance of each agent included in the group;
obtaining global state data indicating collective performance of the group; and
based on the obtained local observation data and the obtained global state data, determining a discount factor for each agent included in the group, wherein
the discount factor is a weight value of a future expected reward for each agent included in the group.
